(19) United States
(12) Patent Application Publication
(10) Pub. No.: US 2026/0351545 A1
(43) Pub. Date: Nov. 5, 2026

(54) METHOD FOR MANUFACTURING POSITIVE ELECTRODE AND METHOD FOR MANUFACTURING SECONDARY BATTERY

(71) Applicant: Prime Planet Energy & Solutions, Inc., Tokyo (JP)

(72) Inventors: Yukitoshi UEHARA, Kobe-shi (JP); Hidekazu HIRATSUKA, Neyagawa-shi (JP)

(21) Appl. No.: 19/457,207

(22) Filed: Jan. 23, 2026

Related U.S. Application Data
(63) Continuation of application No. 18/176,485, filed on Mar. 1, 2023, now abandoned.

(30) Foreign Application Priority Data
Mar. 4, 2022 (JP) 2022-033161

(51) Int. Cl. H01M 4/04; H01M 4/02; H01M 4/1391

(52) U.S. Cl. CPC H01M 4/0404; H01M 4/1391; H01M 2004/021; H01M 2004/028

(57) ABSTRACT

A method for manufacturing a positive electrode disclosed here includes: a CNT paste preparing step of preparing a CNT paste containing at least carbon nanotubes (CNT) and a dispersing agent; a magnetic separating step of exerting a magnetic force on the CNT paste to adsorb metal existing inside the CNTs and separating the CNTs and the metal; a positive electrode active material layer forming paste preparing step of mixing the CNTs subjected to the magnetic separating step, a positive electrode active material, and a binder to prepare a positive electrode active material layer forming paste; and a positive electrode active material layer forming step of applying the prepared positive electrode active material layer forming paste to a positive electrode current collector to form a positive electrode active material layer on the positive electrode current collector.

### CROSS REFERENCE TO RELATED APPLICATION

The present application is a continuation of U.S. application Ser. No. 18/176,485, filed Mar. 1, 2023, which claims the priority based on Japanese Patent Application No. 2022-33161 filed on Mar. 4, 2022, the entire contents of which are incorporated in the present specification by reference.

### BACKGROUND OF THE DISCLOSURE

### 1. Field

The present disclosure relates to a method for manufacturing a positive electrode and a method for manufacturing a secondary battery.

### 2. Background

In recent years, secondary batteries (for example, lithium ion secondary batteries) have been used suitably as driving power sources mounted in portable power sources for, e.g., personal computers and mobile terminals, and in vehicles, e.g., hybrid vehicles (HEV), plug-in hybrid vehicles (PHEV), and electric vehicles (BEV).

A positive electrode of a secondary battery typically has a configuration in which a positive electrode active material layer is provided on a positive electrode current collector. A technology is known in which a conductive material is contained in the positive electrode active material layer in order to improve conductivity. For example, Japanese Patent Application Laid-Open No. 2003-92105 describes that short-time output characteristics of secondary batteries can be improved by using carbon nanotubes (CNT) as one of the conductive materials. Japanese Patent Application Laid-Open No. 2003-92105 describes a method of oxidizing CNTs in a nitric acid solution or the like to open end portions and improve conductivity. Japanese Patent Application Laid-Open No. 2002-255527 describes that electron emission characteristics of CNTs are improved by adsorbing and removing catalytic metals from powdery CNTs by magnetic force of a magnet.

### SUMMARY

However, the present inventors found through intensive studies that, when the end portions are opened by a method of oxidation in a nitric acid solution or the like, there is concern that a structure of the CNTs will be damaged and electrical conductivity of the CNTs will be lowered. In addition, according to a magnetic separation method described in Japanese Patent Application Laid-Open No. 2002-255527, a large amount of catalytic metal remains particularly inside CNTs (for example, inside CNT tubes).

Therefore, there is still room for improvement in treatment from the viewpoint of improving conductivity of CNTs.

It is an object of the present disclosure to provide a method for manufacturing a positive electrode in which output characteristics are improved by further improving the conductivity of CNTs. Another object thereof is to provide a method for manufacturing a secondary battery having excellent output characteristics using the positive electrode manufactured using the method for manufacturing a positive electrode.

According to an aspect of the disclosure, there is provided a method for manufacturing a positive electrode disclosed here, the method being a method for manufacturing a positive electrode of a secondary battery, and including: a carbon nanotube (CNT) paste preparation step of preparing a CNT paste containing at least CNTs and a dispersing agent; a magnetic separation step of exerting a magnetic force on the CNT paste to adsorb metal existing inside the CNTs and separating the CNTs and the metal; a positive electrode active material layer forming paste preparation step of mixing the CNTs subjected to the magnetic separation step, a positive electrode active material, and a binder to prepare a positive electrode active material layer forming paste; and a positive electrode active material layer forming step of applying the prepared positive electrode active material layer forming paste to a positive electrode current collector to form a positive electrode active material layer on the positive electrode current collector.

According to such a configuration, the end portions of the CNTs can be opened without damaging the structure of the CNTs, and the metal present on the surface and inside of the CNTs can be suitably removed. As a result, the conductivity of the CNTs can be further improved, and a method for manufacturing a positive electrode with excellent output characteristics can be provided.

In the aspect of the method for manufacturing a positive electrode disclosed here, the CNTs separated in the magnetic separation step have a metal content of 1.6% by mass or less when a total of the CNTs and the metal is 100% by mass.

According to such a configuration, the positive electrode can be manufactured to provide the secondary battery with even more excellent output characteristics.

In the aspect of the method for manufacturing a positive electrode disclosed here, the positive electrode active material layer formed in the positive electrode active material layer forming step has a basis weight on both sides of 10 mg/cm² or more and 50 mg/cm² or less. According to another preferred aspect, the positive electrode active material layer formed in the positive electrode active material layer forming step has a porosity of 20% or more and 50% or less.

According to such a configuration, excellent output characteristics can be imparted to the secondary battery.

In addition, the technology disclosed herein provides a method for manufacturing a secondary battery. In the method for manufacturing a secondary battery disclosed here, the secondary battery is constructed using the positive electrode manufactured by the method for manufacturing a positive electrode described above.

According to such a configuration, it is possible to suitably manufacture a secondary battery having excellent output characteristics.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a flowchart of a method for manufacturing a positive electrode according to an embodiment;

FIG. 2 is a longitudinal sectional view schematically showing an internal structure of a lithium ion secondary battery according to the embodiment; and

FIG. 3 is a view schematically showing a configuration of an electrode body of the lithium ion secondary battery according to the embodiment.

### DETAILED DESCRIPTION OF THE PREFERRED EMBODIMENTS

Hereinafter, an embodiment of a technology disclosed here will be described. It is needless to say that the embodiments described herein are not intended to specifically limit the disclosure. The technology disclosed herein is not limited to the embodiments described herein, unless otherwise stated. Each drawing is drawn schematically and does not necessarily reflect the actual objects. Moreover, in each drawing, members and parts having the same function will be given the same reference numerals, and redundant description thereof will be omitted or simplified. The dimensional relationships (length, width, thickness, and the like) in the drawings do not reflect the actual dimensional relationships. In addition, A and B are included in the numerical range expressed as “A to B” in this specification.

As used herein, the term “secondary battery” refers to a general battery that can be repeatedly charged, and in addition to so-called storage batteries such as lithium ion secondary batteries and nickel metal hydride batteries, the term also includes capacitors such as electric double layer capacitors. In this specification, the term “lithium ion secondary battery” refers to a secondary battery that utilizes lithium ions as a charge carrier and is charged/discharged by the transfer of charge associated with the lithium ions between the positive and negative electrodes.

Hereinafter, the technology disclosed herein will be described by taking, as an example, a method for manufacturing a positive electrode for a lithium ion secondary battery having a wound electrode body and a method for manufacturing the lithium ion secondary battery, but the disclosure is not intended to limit the technology disclosed herein to the description in such embodiments.

### 1. Method for Manufacturing Positive Electrode

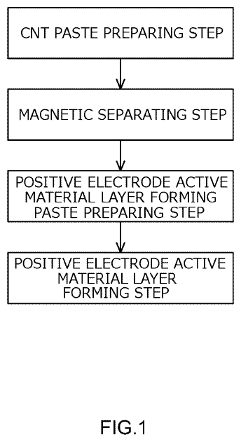

FIG. 1 is a flowchart of a method for manufacturing a positive electrode disclosed herein. As shown in FIG. 1, a method for manufacturing a positive electrode disclosed here includes the following steps: a carbon nanotube (CNT) paste preparing step of preparing a CNT paste containing at least CNTs and a dispersing agent; a magnetic separating step of exerting a magnetic force on the CNT paste to adsorb metals existing inside the CNTs and separating the CNTs and the metal; a positive electrode active material layer forming paste preparing step of mixing the CNTs subjected to the magnetic separating step, a positive electrode active material, and a binder to prepare a positive electrode active material layer forming paste; and a positive electrode active material layer forming step of applying the prepared positive electrode active material layer forming paste to a positive electrode current collector to form a positive electrode active material layer on the current collector.

### (1) CNT Paste Preparing Step

In the CNT paste preparing step, at least the CNTs and a dispersing agent are mixed with a suitable solvent to prepare the CNT paste. As used herein, the term “paste” refers to a mixture in which a part or all of the solid content is dispersed in a solvent, and includes so-called “slurry,” “ink,” and the like.

The CNTs used in the CNT paste preparation step are not particularly limited. The CNTs may be, for example, single-walled carbon nanotubes (SWNT), double-walled carbon nanotubes (DWNT), or multi-walled carbon nanotubes (MWNT). These can be used alone, or two or more thereof can be used in combination. Among them, it is preferable to use multi-walled carbon nanotubes. The CNTs may be manufactured by chemical vapor deposition (CVD), arc discharge, laser ablation, or the like.

The average length of the CNTs is not particularly limited. When the average length of the CNTs is extremely long, the CNTs aggregate and are not uniformly dispersed, possibly reducing the effect of improving electron conductivity. Therefore, the average length of the CNTs is preferably 0.1 μm or more and 50 μm or less, may be 0.2 μm or more and 30 μm or less, may be 0.5 μm or more and 10 μm or less, or may be 0.5 μm or more and 5 μm or less. The average diameter of the CNTs is not particularly limited. The average diameter of the CNTs may be, for example, 0.1 nm or more and 30 nm or less, 1 nm or more and 25 nm or less, 5 nm or more and 20 nm or less, or 10 nm or more and 20 nm or less. The average length and average diameter of the CNTs can be obtained, respectively, for example, by taking an electron micrographs of the CNTs and calculating the average length and diameter of 20 or more of the CNTs. The aspect ratio (average length/average diameter) of the CNTs may be, for example, 10 or more and 1500 or less, preferably 100 or more and 1000 or less.

The CNTs may be prepared by selecting and purchasing CNTs having the above-described average length, average diameter, and the like from commercially available CNTs.

The dispersing agent may be any of so-called surfactant dispersing agents (also referred to as low-molecular-weight dispersing agents), polymer dispersing agents, inorganic dispersing agents, and the like. In addition, these dispersing agents may be anionic, cationic, amphoteric, or nonionic. That is, the dispersing agent may have at least one functional group selected from an anionic group, a cationic group, and a nonionic group in the molecular structure thereof. The term “surfactant” refers to an amphiphilic substance having a chemical structure in which a hydrophilic site and a lipophilic site are provided in the molecular structure and these sites are covalently bonded.

Specifically, dispersing agents composed of sulfonic acid compounds such as sodium salt of naphthalenesulfonic acid formalin condensate and ammonium salt of naphthalenesulfonic acid formalin condensate; dispersing agents composed of acrylic compounds such as polyacrylic acid salts and polymethacrylic acid salts; dispersing agents composed of copolymers containing aromatic units such as pyrene and anthracene; triazine-based dispersing agents (for example, those containing a carbazole group or a benzimidazolyl group as a heterocyclic group which may have a substituent); polyvinylpyrrolidone (PVP); polyvinylidene fluoride (PVdF), and the like can be preferably used. Among them, a dispersing agent composed of a copolymer containing an aromatic unit such as pyrene or anthracene is preferable. Any one of these dispersing agents may be used alone, or two or more thereof may be used in combination. It is speculated that the inclusion of the dispersing agent as described above in the CNT paste makes the metal existing inside the CNTs more slippery. As a result, the CNTs and the metal can be suitably separated without damaging the structure of the CNTs in the magnetic separation step, which will be described later.

The content of the dispersing agent is not particularly limited, but when the mass of the CNTs is 100% by mass, for example, approximately 1% by mass to 50% by mass can be used as a rough guide.

The solvent may be an aqueous solvent or a non-aqueous solvent (liquid solvent). As the aqueous solvent, a composition composed of water or a mixed solvent containing water as a main component can be used. As a non-aqueous solvent, for example, N-methylpyrrolidone (NMP) can be preferably used.

### (2) Magnetic Separating Step

In the magnetic separating step, a magnetic force is exerted on the CNT paste prepared above to separate the CNTs from the metal adhering to the CNTs. Here, the metal separated by magnetic separation is a ferromagnetic metal that can be adsorbed to a magnetic force source side when a magnetic force is exerted on the CNT paste using a magnetic force source (for example, a permanent magnet or an electromagnet). Such a ferromagnetic metal adhering to the CNT is typically derived from the catalytic metal used when manufacturing the CNT. Examples of such catalytic metals include iron (Fe), chromium (Cr), nickel (Ni), cobalt (Co), and the like. When CNTs containing such a metal therein are used as the conductive material of the positive electrode, there is a concern that the conductivity may not be exhibited sufficiently. When the CNTs are treated with an acid solution such as nitric acid to remove such metals, the structure of the CNTs may be damaged and the conductivity may be lowered. Moreover, when the dry magnetic separation method is applied to powdery CNTs, the conductivity of the CNTs is not sufficiently improved because the metal existing inside the CNTs is not suitably removed. Therefore, in the manufacturing method disclosed herein, CNTs and metals are separated by a wet magnetic separation method in which a magnetic force source is brought into contact with the CNT paste. As described above, the CNT paste contains a dispersing agent, and the dispersing agent makes the metal existing in the CNT slippery, and accordingly, the metal existing on the surface or inside of the CNT can be suitably removed. That is, according to the technology disclosed herein, the end portions of the CNTs can be opened without damaging the structure of the CNTs, and the metal existing inside the CNTs (that is, inside the tubular structure of the CNTs) can be suitably removed. Accordingly, it becomes easier for the electrolytic solution to penetrate into the inside of the CNTs, and for example, the movement of Li ions is improved, and thus, it is possible to manufacture a positive electrode that improves the output characteristics of a secondary battery.

The magnetic separation method is not particularly limited as long as it is possible to perform wet magnetic separation in which a magnetic force source is brought into contact with the CNT paste. For example, magnetic separation method can be performed using a known wet magnetic separator. The magnets used in the magnetic separation step may be permanent magnets such as alnico magnets, ferrite magnets, neodymium magnets, or electromagnets. The shape, size, surface area, and the like of the magnet can be appropriately selected. The magnetic force of the magnet used in the magnetic separation step (the magnetic force at the location in contact with the CNT paste) may be approximately 100 millitesla (mT) or more and 1000 millitesla (mT) or less (for example, 200 mT or more and 800 mT or less, preferably 400 mT or more and 700 mT or less). In addition, by adjusting the number of times the CNT paste is passed through the magnet and the flow rate when the magnet is passed, the metal content on the surface and inside of the CNT can be further reduced.

Although not particularly limited, the CNTs separated in the magnetic separation step preferably have a metal content of 3% by mass or less when the total of the CNTs and the metal is 100% by mass. More preferably, the CNTs separated in the magnetic separation step have a metal content of less than 2% by mass when the total of the CNTs and the metal is 100% by mass, and more preferably have a metal content of 1.6% by mass or less, particularly preferably have a metal content of 1.2% by mass or less, and for example, the metal content may be 1% by mass or less. In particular, when the metal content in the separated CNTs is 1.6% by mass or less, the effect of reducing the output resistance is further exhibited by suitably removing the metal existing inside the CNTs.

In addition, the metal content in the CNTs separated in the magnetic separation step can be determined, for example, by subjecting the CNTs to quantitative analysis by inductively coupled plasma mass spectrometry (ICP-MS).

### (3) Positive Electrode Active Material Layer Forming Paste Preparing Step

In the positive electrode active material layer forming paste preparing step, the CNT subjected to the magnetic separating step, the positive electrode active material, and the binder are mixed. The positive electrode active material layer forming paste may be prepared by further adding a positive electrode active material and a binder to the CNT paste subjected to the magnetic separation step and mixing them, or may be prepared by collecting the CNTs separated in the magnetic separation step and mixing the CNTs, positive electrode active material, and binder with another suitable solvent. Preferably, the positive electrode active material and the binder may further be added to the CNT paste subjected to the magnetic separation step and mixed. As a result, the CNTs suitably dispersed in the CNT paste can be mixed with the positive electrode active material and the binder, and superior output characteristics can be imparted to the secondary battery. At this time, the content of CNT in the total solid content constituting the positive electrode active material layer forming paste is, for example, 0.1% by mass or more and 3% by mass or less (preferably 0.35% by mass or more and 1.5% by mass or less, more preferably 0.35% by mass or more and 1% by mass or less).

As the positive electrode active material, one or two or more materials conventionally used in this type of secondary battery can be used without particular limitation. Examples thereof include lithium transition metal oxides (for example, LiNi_{1/3}Co_{1/3}Mn_{1/3}O₂, LiNiO₂, LiCoO₂, LiFeO₂, LiMn₂O₄, LiNi_{0.5}Mn_{1.5}O₄) and lithium transition metal phosphate compounds (for example, LiFePO₄). Although the properties of the positive electrode active material are not particularly limited, the positive electrode active material is typically particulate. The average particle size of the particulate positive electrode active material is not particularly limited, and may be, for example, 25 μm or less (typically 1 μm or more and 25 μm or less, preferably 5 μm or more and 20 μm or less). The content of the positive electrode active material in the total solid content constituting the positive electrode active material layer forming paste, is preferably 50% by mass or more, for example, 80% by mass or more and 99.5% by mass or less, or 85% by mass or more and 98.5% by mass or less. In the present specification, the “average particle size” refers to a particle size (D50, also referred to as median diameter) corresponding to a cumulative frequency of 50% by volume from the fine particle side with a small particle size in a volume-based particle size distribution based on a general laser diffraction/light scattering method.

As the binder, any material conventionally used as a binder in this type of secondary battery can be used without any particular limitation. For example, as the binder, fluorine-based binders such as polyvinylidene fluoride (PVdF) and polytetrafluoroethylene (PTFE), and rubber-based binders such as styrene-butadiene rubber (SBR) can be suitably used. The content of the binder in the total solid content constituting the positive electrode active material layer forming paste, is preferably 0.1% by mass or more and 3% by mass or less, preferably 0.2% by mass or more and 1.5% by mass or less, or 0.5% by mass or more and 1% by mass or less.

The positive electrode active material layer forming paste may contain, as a solid content, substances other than the above-described positive electrode active material and binder within a range that does not significantly hinder the technology disclosed herein. Examples thereof include conductive materials other than CNT and various additives. Examples of conductive materials other than CNT include carbon black (for example, acetylene black, furnace black, and Ketjen black), and coke.

### (4) Positive Electrode Active Material Layer Forming Step

In the positive electrode active material layer forming step, the prepared positive electrode active material layer forming paste is applied to a positive electrode current collector to form a positive electrode active material layer on the positive electrode current collector. As the positive electrode current collector, a metal having good conductivity, an alloy thereof, or the like, which is the same as the current collector used for the positive electrode of a conventional secondary battery, can be used. As the positive electrode current collector, for example, an aluminum foil having a thickness of approximately 10 μm to 30 μm can be suitably used. The dimension of the positive electrode current collector is not particularly limited, and may be appropriately determined according to the battery design.

The coating treatment of the positive electrode active material layer forming paste can be performed according to a conventionally known method. For example, the coating treatment can be performed by applying the positive electrode active material layer forming paste onto the surface of the positive electrode current collector using an apparatus such as a slit coater, a die coater, a comma coater, a gravure coater, and a dip coater. The positive electrode active material layer forming paste may be applied to one side or both sides of the positive electrode current collector. In addition, the coating amount of the positive electrode active material layer forming paste is not particularly limited, and can be set in any manner according to the intended battery characteristics and the like. For example, basis weight on both surfaces in the coating amount of the positive electrode active material layer forming paste is preferably 10 mg/cm² to 50 mg/cm² on both sides, and more preferably 11 mg/cm² to 44 mg/cm².

After the coating treatment, drying treatment is usually performed to dry the applied positive electrode active material layer forming paste. Although the drying method is not particularly limited, for example, it is possible to evaporate (volatilize) the solvent from the positive electrode current collector coated with the positive electrode active material layer forming paste using a drying device such as a drying furnace. The drying temperature and drying time are not particularly limited, and may be appropriately set according to the amount of the solvent contained in the positive electrode active material layer forming paste. For example, the drying temperature is preferably approximately 70 °C to 200 °C (typically 100 °C to 180 °C). Thereby, a positive electrode active material layer is formed on the positive electrode current collector.

After the drying treatment, press treatment may be performed as necessary. By the press treatment, a positive electrode active material layer having a desired thickness, density, and porosity can be obtained. For example, by properly controlling the press treatment conditions, the porosity of the formed positive electrode active material layer can be adjusted to a desired value within the range of approximately 20% to 50%. As a pressing method, for example, a conventionally known compression (pressing) method such as a roll pressing method or a flat plate pressing method can be employed. Thereby, the resistance of the secondary battery can be suitably reduced. In addition, the porosity of the formed positive electrode active material layer can be obtained by a mercury intrusion method. The porosity of the formed positive electrode active material layer can also be adjusted by changing the compounding ratio and solid content of the positive electrode active material layer forming paste.

As described above, a positive electrode in which a positive electrode active material layer is formed on a positive electrode current collector can be manufactured. The positive electrode obtained by the production method disclosed herein has the advantage of improving the output characteristics of the secondary battery.

An embodiment of a secondary battery (specifically, a lithium ion secondary battery) using the positive electrode obtained by the manufacturing method disclosed herein will be described below with reference to the drawings.

### 2. Method for Manufacturing Secondary Battery

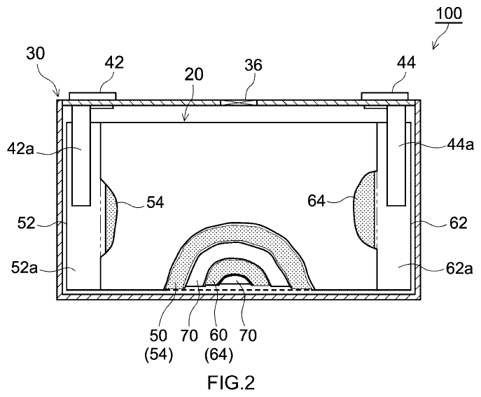

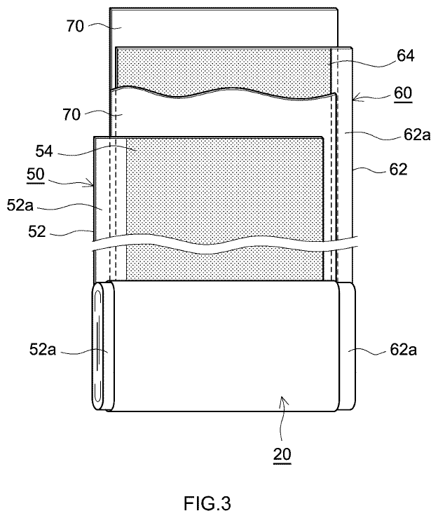

FIG. 2 is a longitudinal sectional view of a lithium ion secondary battery according to one embodiment, and FIG. 3 is a diagram schematically showing the internal structure of the lithium ion secondary battery. A lithium ion secondary battery 100 shown in FIG. 2 is a sealed battery constructed by accommodating an electrode body 20 and a non-aqueous electrolytic solution (not shown) in a flat rectangular battery case (that is, an outer container) 30. The battery case 30 is provided with a positive electrode terminal 42 and a negative electrode terminal 44 for external connection, and a thin safety valve 36 set to release the internal pressure when the internal pressure of the battery case 30 rises to be equal to or higher than a predetermined level. Further, the battery case 30 is provided with a liquid injection hole (not shown) for injecting a non-aqueous electrolytic solution. The positive electrode terminal 42 is electrically connected to a positive electrode power collection plate 42a. The negative electrode terminal 44 is electrically connected to a negative electrode power collection plate 44a. As the material of the battery case 30, for example, a metal material such as aluminum that is lightweight and has good thermal conductivity is used.

As shown in FIG. 3, the electrode body 20 includes a long sheet-shaped positive electrode 50 (hereinafter also referred to as “positive electrode sheet 50”) and a long sheet-shaped negative electrode 60 (hereinafter also referred to as “negative electrode sheet 60”), and a long sheet-shaped separator 70 (hereinafter also referred to as “separator sheet 70”). The electrode body 20 may be, for example, a wound electrode body in which the positive electrode sheet 50 and the negative electrode sheet 60 are stacked with two separator sheets 70 interposed therebetween and wound in the longitudinal direction.

Note that the electrode body 20 is not limited to a wound electrode body. The electrode body 20 may be, for example, a laminated electrode body in which a predetermined number of positive electrode sheets and negative electrode sheets are alternately laminated with a separator sheet interposed therebetween.

A positive electrode (positive electrode sheet) obtained by the manufacturing method described above is used for the positive electrode sheet 50. The positive electrode sheet 50 has a configuration in which a positive electrode active material layer 54 is formed along the longitudinal direction on one side or both sides (here, both sides) of a long positive electrode current collector 52. A positive electrode current collector exposed portion 52a (that is, a part where the positive electrode current collector 52 is exposed without the positive electrode active material layer 54 being formed) is formed to protrude outward from both ends in the winding axial direction (that is, a sheet width direction perpendicular to the longitudinal direction) of the electrode body 20. The positive electrode power collection plate 42a is bonded to the positive electrode current collector exposed portion 52a.

As shown in FIG. 3, the negative electrode sheet 60 has a configuration in which a negative electrode active material layer 64 is formed along the longitudinal direction on one side or both sides (here, both sides) of a long negative electrode current collector 62. As the material of the negative electrode current collector 62, metals with good conductivity (for example, copper, nickel, titanium, and stainless steel) can be used as in conventional secondary batteries. As the negative electrode current collector 62, a copper foil having a thickness of, for example, approximately 5 μm to 35 μm is preferable. The dimension of the negative electrode current collector 62 is not particularly limited, and may be appropriately determined according to the battery design. A negative electrode current collector exposed portion 62a (that is, a part where the negative electrode current collector 62 is exposed without the negative electrode active material layer 64 being formed) is formed to protrude outward from both ends in the winding axial direction (that is, a sheet width direction perpendicular to the longitudinal direction) of the electrode body 20. The negative electrode power collection plate 44a is bonded to the negative electrode current collector exposed portion 62a.

The negative electrode active material layer 64 contains at least a negative electrode active material capable of intercalating/deintercalating lithium ions, which are charge carriers. Carbon materials such as graphite, hard carbon, and soft carbon can be used as the negative electrode active material. The negative electrode active material layer 64 may contain components other than the active material, such as binders and thickening agents. As the binder, for example, styrene-butadiene rubber (SBR) or the like can be used. As a thickening agent, for example, carboxymethyl cellulose (CMC) or the like can be used.

Although not particularly limited, when the total solid content of the negative electrode active material layer 64 is 100% by mass, the content of the negative electrode active material is preferably 60% by mass or more, for example, 90% by mass to 99% by mass, more preferably 92% by mass to 98% by mass. Further, when a binder is used, the content of the binder in the negative electrode active material layer 64 is, for example, preferably 1% by mass to 10% by mass, more preferably 1% by mass to 5% by mass. When a thickening agent is used, the content of the thickening agent in the negative electrode active material layer 64 is, for example, preferably 1% by mass to 10% by mass, more preferably 1% by mass to 5% by mass.

The negative electrode active material layer 64 can be produced, for example, typically by coating the negative electrode current collector 62 with a negative electrode active material layer forming paste prepared by mixing a negative electrode active material, a binder, and a thickening agent with a suitable solvent (for example, ion-exchanged water), and drying it. In addition, the thickness, density, and the like of the negative electrode active material layer 64 can be adjusted by performing press treatment as necessary.

The separator sheet 70 is arranged between the positive electrode active material layer 54 of the positive electrode sheet 50 and the negative electrode active material layer 64 of the negative electrode sheet 60 to insulate the positive electrode active material layer 54 and the negative electrode active material layer 64. The separator sheet 70 is composed of a porous resin base material. Examples of resin base materials include sheets (films) made of resins such as polyolefins (for example, polyethylene (PE) and polypropylene (PP)), polyesters, polyamides, and cellulose. The separator sheet 70 may have a single-layer structure, and may have a structure in which two or more types of porous resin sheets having different properties and characteristics (thickness, porosity, and the like) are laminated (for example, a three-layered structure in which a PP layer on both sides of a PE layer). Moreover, the separator sheet 70 may have a heat resistant layer (HRL layer) made of ceramic particles or the like on the surface thereof. The HRL may be the same as the heat resistant layer provided in the separator of a known non-aqueous electrolytic solution secondary battery, and examples thereof include ceramic particles such as alumina, silica, boehmite, magnesia, and titania, and binders such as PVdF.

As shown in FIG. 3, one end portion of the positive electrode sheet 50 along the longitudinal direction is provided with a part where the positive electrode active material layer 54 is not formed (positive electrode current collector exposed portion 52a). One end portion of the negative electrode sheet 60 along the longitudinal direction is provided with a part where the negative electrode active material layer 64 is not formed (negative electrode current collector exposed portion 62a). The electrode body 20 can be produced, for example, according to a known method. Specifically, for example, the positive electrode sheet 50 and the negative electrode sheet 60 are laminated with two separators 70 interposed therebetween to produce a laminated body, which is then wound in the longitudinal direction. At this time, the positive electrode current collector exposed portion 52a and the negative electrode current collector exposed portion 62a are wound to protrude outward respectively from both end portions of the electrode body 20 in the winding axial direction. In this manner, the electrode body 20 can be produced. In order to obtain a flattened wound electrode body as shown in FIG. 3, the laminated body may be wound in a flattened shape, a cylindrical wound body of the laminated body may be produced first, and then this may be pressed from the side to be twisted.

Next, the obtained electrode body 20 is electrically connected to each of the positive electrode terminal 42 and the negative electrode terminal 44 for external connection. Then, the electrode body 20 to which the positive electrode terminal 42 and the negative electrode terminal 44 are connected is accommodated in the battery case 30, and the battery case 30 is sealed by injecting an appropriate non-aqueous electrolyte. In this manner, the lithium ion secondary battery 100 according to the present embodiment can be constructed.

In addition, the electrolyte may be the same as the conventional one, and there is no particular limitation. The electrolyte is, for example, a non-aqueous electrolytic solution containing a non-aqueous solvent and a supporting salt. Non-aqueous solvents include, for example, carbonates such as ethylene carbonate, dimethyl carbonate, and ethylmethyl carbonate. The supporting salt is, for example, a fluorine-containing lithium salt such as LiPF₆. In addition, the non-aqueous electrolyte may contain components other than the components described above, such as film-forming agents (for example, lithium bis(oxalato)borate (LiBOB) and vinylene carbonate (VC)), and gas generating agents (for example, biphenyl (BP) and cyclohexylbenzene (CHB)) as long as the effects of the present disclosure are not significantly impaired.

The lithium ion secondary battery 100 obtained as described above has an advantage of improved output characteristics. The lithium ion secondary battery 100 can be used for various purposes. Preferred applications include driving power sources mounted in vehicles such as hybrid electric vehicles (HEV), plug-in hybrid electric vehicles (PHEV), and battery electric vehicles (BEV). Moreover, the lithium ion secondary battery 100 can also be used in the form of an assembled battery in which a plurality of batteries are connected in series and/or in parallel.

Examples relating to the present disclosure will be described below, but the present disclosure is not intended to be limited to those shown in the examples.

### TEST EXAMPLE

### 1. First Test

### (1) Example 1

First, CNTs and a copolymer containing a pyrene aromatic unit as a dispersing agent were mixed with N-methylpyrrolidone (NMP) as a solvent to prepare a CNT paste. The CNTs were multi-walled carbon nanotubes manufactured by chemical vapor deposition using Co as a catalytic metal and having an average diameter of 10 nm to 20 nm and an average length of 0.5 μm to 5 μm. Next, LiNi_{1/3}Co_{1/3}Mn_{1/3}O₂ as a positive electrode active material and polyvinylidene fluoride (PVdF) as a binder were prepared. The positive electrode active material, CNT, and PVdF are mixed in the CNT paste to have a mass ratio of positive electrode active material:CNT:PVdF=99.15:0.35:0.50 to prepare a positive electrode active material layer forming paste. This positive electrode active material layer forming paste was applied to both sides of an aluminum foil, dried, and pressed to obtain a positive electrode having a positive electrode active material layer formed on a positive electrode current collector. The positive electrode thus formed had a basis weight on both sides of 44 mg/cm² and a porosity of 20% as measured by a mercury intrusion method.

Graphite (C) as a negative electrode active material, CMC as a thickening agent, and SBR as a binder are mixed with ion-exchanged water at a mass ratio of C:CMC:SBR=98:1:1 to prepare a negative electrode active material layer forming paste. This negative electrode active material layer forming paste was applied to both sides of a copper foil, dried, and pressed to obtain a negative electrode having a negative electrode active material layer formed on a negative electrode current collector.

A single-layer polypropylene sheet was used as the separator.

The positive electrode and the negative electrode prepared above were laminated with the separator prepared above interposed therebetween to produce a laminated electrode body.

A positive electrode terminal and a negative electrode terminal were connected to the laminated electrode body produced above, and the assembly was accommodated in a rectangular battery case having an electrolyte liquid injection hole. Subsequently, a non-aqueous electrolytic solution was injected through the liquid injection hole of the battery case, and the liquid injection hole was airtightly sealed. The non-aqueous electrolytic solution was prepared by adding 1% by mass of vinylene carbonate (VC) to a mixed solvent containing ethylene carbonate (EC), dimethyl carbonate (DMC), and ethyl methyl carbonate (EMC) at a volume ratio of EC:DMC:EMC=3:4:3, and dissolving LiPF₆ as a supporting salt at a concentration of 1.15 mol/L. After that, an activation treatment was performed to obtain a secondary battery for evaluation of Example 1.

### (2) Example 2

The same CNT as in Example 1 and a copolymer containing a pyrene aromatic unit as a dispersing agent were mixed with N-methylpyrrolidone (NMP) as a solvent to prepare a CNT paste. Next, a magnetic separation step was performed such that the metal content when the total of CNTs and metal is 100% by mass in the separated CNTs (hereinafter referred to as “metal content”) was 2% by mass. Specifically, the CNT paste was passed once through a magnetic separator using a neodymium magnet (permanent magnet) with a magnetic flux density of 400 millitesla (mT).

To the above CNT paste, LiNi_{1/3}Co_{1/3}Mn_{1/3}O₂ as a positive electrode active material and polyvinylidene fluoride (PVdF) as a binder were mixed such that the mass ratio satisfied positive electrode active material:CNT:PVdF=99.15:0.35:0.50 to prepare the positive electrode active material layer forming paste. This positive electrode active material layer forming paste was applied to both sides of an aluminum foil, dried, and pressed to obtain a positive electrode having a positive electrode active material layer formed on a positive electrode current collector. The positive electrode thus formed had a basis weight on both sides of 44 mg/cm² and a porosity of 20% as measured by a mercury intrusion method. A secondary battery for evaluation of Example 2 was produced in the same manner as in Example 1 except for the positive electrode described above.

### (3) Examples 3 to 5

The number of times of passing through the magnetic separator was changed such that the metal content (% by mass) in the magnetic separation step was the value shown in Table 1. Secondary batteries for evaluation of Examples 3 to 5 were produced in the same manner as in Example 2 except for this.

### (4) Example 6

The same CNTs as in Example 1 were passed four times in a powdery state through a magnetic separator using neodymium magnets (permanent magnets) with a magnetic flux density of 400 millitesla (mT). Secondary batteries for evaluation of Example 6 were produced in the same manner as in Example 1 except for this.

### (5) Example 7

The same CNTs as in Example 1 were subjected to an acid treatment using nitric acid, filtered, and used as a conductive material. A secondary battery for evaluation of Example 7 was produced in the same manner as in Example 1 except for this.

### (6) Output Resistance Evaluation

Each secondary battery for evaluation was prepared to an SOC (State of Charge) of 50% by constant-current-constant-voltage (CC-CV) charging, and then placed in an environment of 25 °C. Discharge was performed for 10 seconds at a current value of 5 C, and the voltage drop amount ΔV at this time was obtained. Using the voltage drop amount ΔV and the current value, the output resistance value of each secondary battery for evaluation was calculated. It can be said that as the output resistance value decreases, the output characteristics increase. The results are shown in Table 1.

TABLE 1

| | | | | | | Number of times of | Output |
|---|---|---|---|---|---|---|---|
| | positive electrode | | | | | passing through | resistance |
| | active material | CNT | PVdF | Metal content | Catalytic metal | permanent magnet | value |
| | (% by mass) | (% by mass) | (% by mass) | (% by mass) | removal method | (number of times) | (mΩ) |
| Example 1 | 99.15 | 0.35 | 0.50 | 4.0 | None | 0 | 72.3 |
| Example 2 | 99.15 | 0.35 | 0.50 | 2.0 | Magnetic separation | 1 | 72.0 |
| | | | | | (paste) | | |
| Example 3 | 99.15 | 0.35 | 0.50 | 1.6 | Magnetic separation | 2 | 69.5 |
| | | | | | (paste) | | |
| Example 4 | 99.15 | 0.35 | 0.50 | 1.2 | Magnetic separation | 4 | 68.3 |
| | | | | | (paste) | | |
| Example 5 | 99.15 | 0.35 | 0.50 | 0.4 | Magnetic separation | 10 | 67.5 |
| | | | | | (paste) | | |
| Example 6 | 99.15 | 0.35 | 0.50 | 1.2 | Magnetic separation | 4 | 72.6 |
| | | | | | (powder) | | |
| Example 7 | 99.15 | 0.35 | 0.50 | 0.0 | Nitric acid cleaning | 0 | 71.1 |

As shown in Table 1, by preparing the CNT paste and performing the magnetic separation step, compared to Example 1 in which the magnetic separation step was not performed and Example 6 in which the magnetic separation was performed in a powdery state, it was found that the output resistance value decreased. This is presumed to be due to the fact that the metal existing in the CNTs becomes slippery due to the dispersing agent contained in the CNT paste and the removal of the metal is accelerated by performing the magnetic separation step in the state of the CNT paste. In addition, as shown in Example 7, by removing the metal by nitric acid cleaning, the metal content in the CNT after nitric acid cleaning is 0% by mass, but the output resistance value is higher than Example 3 with a metal content of 1.6% by mass. That is, it is presumed that when the metal is removed by nitric acid cleaning, the conductivity of the CNT is lowered by damaging the CNT.

Therefore, a CNT paste containing at least CNTs and a dispersing agent is prepared, a magnetic force is exerted on the CNT paste to adsorb the metal existing inside the CNTs, and a magnetic separation step is performed to separate the CNTs and the metal. Then, by manufacturing a positive electrode using the CNT subjected to the magnetic separation step as a conductive material, it is possible to manufacture a positive electrode that imparts excellent output characteristics to a secondary battery.

In addition, in Examples 3 to 5 in which the magnetic separation step was performed such that the metal content in the CNT after the magnetic separation step was 1.6% by mass or less, it was found that the output resistance value decreased. This is presumed that when the metal content in the separated CNTs is 1.6% by mass or less, the metal existing inside the CNTs is also suitably removed. As a result, the non-aqueous electrolytic solution easily penetrates into the inside of the CNT, Li ions move easily, and thus, it is presumed that the output resistance value decreased.

### 2. Second Test

In the second test, the output resistance of the secondary battery was evaluated when the composition ratio of the positive electrode, the basis weight on both sides, and the porosity were changed from those in the first test.

### (1) Example 11

First, CNTs and a copolymer containing a pyrene aromatic unit as a dispersing agent were mixed with N-methylpyrrolidone (NMP) as a solvent to prepare a CNT paste. The CNTs were multi-walled carbon nanotubes manufactured by chemical vapor deposition using Co as a catalytic metal and having an average diameter of 10 nm to 20 nm and an average length of 0.5 μm to 5 μm. Next, LiNi_{1/3}Co_{1/3}Mn_{1/3}O₂ as a positive electrode active material and polyvinylidene fluoride (PVdF) as a binder were prepared. Mixing was performed in the CNT paste to have a mass ratio of positive electrode active material:CNT:PVdF=98.3:1.0:0.7 to prepare a positive electrode active material layer forming paste. This positive electrode active material layer forming paste was applied to both sides of an aluminum foil, dried, and pressed to obtain a positive electrode having a positive electrode active material layer formed on a positive electrode current collector. The positive electrode thus formed had a basis weight on both sides of 11 mg/cm² and a porosity of 50% as measured by a mercury intrusion method.

Graphite (C) as a negative electrode active material, CMC as a thickening agent, and SBR as a binder are mixed with ion-exchanged water at a mass ratio of C:CMC:SBR=98:1:1 to prepare a negative electrode active material layer forming paste. The negative electrode active material layer forming paste was applied to both sides of a copper foil, dried, and pressed to produce a negative electrode.

A single-layer polypropylene sheet was used as the separator.

The positive electrode and the negative electrode prepared above were laminated with the separator prepared above interposed therebetween to produce a laminated electrode body.

A positive electrode terminal and a negative electrode terminal were connected to the laminated electrode body produced above, and the assembly was accommodated in a rectangular battery case having an electrolyte liquid injection hole. Subsequently, a non-aqueous electrolytic solution was injected through the liquid injection hole of the battery case, and the liquid injection hole was airtightly sealed. The non-aqueous electrolytic solution was prepared by adding 1% by mass of vinylene carbonate (VC) to a mixed solvent containing ethylene carbonate (EC), dimethyl carbonate (DMC), and ethyl methyl carbonate (EMC) at a volume ratio of EC:DMC:EMC=3:4:3, and dissolving LiPF₆ as a supporting salt at a concentration of 1.15 mol/L. After that, an activation treatment was performed to obtain a secondary battery for evaluation of Example 11.

### (2) Example 12

The same CNT as in Example 11 and a copolymer containing a pyrene aromatic unit as a dispersing agent were mixed with N-methylpyrrolidone (NMP) as a solvent to prepare a CNT paste. Next, a magnetic separation step was performed such that the metal content in the separated CNTs was 2% by mass. Specifically, the CNT paste was passed once through a magnetic separator using a neodymium magnet (permanent magnet) with a magnetic flux density of 400 millitesla (mT).

To the above CNT paste, LiNi_{1/3}Co_{1/3}Mn_{1/3}O₂ as a positive electrode active material and polyvinylidene fluoride (PVdF) as a binder were mixed in the CNT paste such that the mass ratio satisfied positive electrode active material:CNT:PVdF=98.3:1.0:0.7 to prepare the positive electrode active material layer forming paste. This positive electrode active material layer forming paste was applied to both sides of an aluminum foil, dried, and pressed to obtain a positive electrode having a positive electrode active material layer formed on a positive electrode current collector. The positive electrode thus formed had a basis weight on both sides of 11 mg/cm² and a porosity of 50% as measured by a mercury intrusion method.

A secondary battery for evaluation of Example 12 was produced in the same manner as in Example 11 except for the positive electrode described above.

### (3) Examples 13 to 15

The number of times of passing through the magnetic separator was changed such that the metal content (% by mass) in the magnetic separation step was the value shown in Table 2. Secondary batteries for evaluation of Examples 13 to 15 were produced in the same manner as in Example 12 except for this.

### (4) Example 16

The same CNTs as in Example 11 were passed four times in a powdery state through a magnetic separator using neodymium magnets (permanent magnets) with a magnetic flux density of 400 millitesla (mT). A secondary battery for evaluation of Example 16 was produced in the same manner as in Example 11 except for this.

### (5) Example 17

The same CNTs as in Example 11 were subjected to an acid treatment using nitric acid, filtered, and used as a conductive material. A secondary battery for evaluation of Example 17 was produced in the same manner as in Example 11 except for this.

### (6) Output Resistance Evaluation

Each secondary battery for evaluation was prepared to an SOC (State of Charge) of 50% by constant-current-constant-voltage (CC-CV) charging, and then placed in an environment of 25 °C. Discharge was performed for 10 seconds at a current value of 5 C, and the voltage drop amount ΔV at this time was obtained. Using the voltage drop amount ΔV and the current value, the output resistance value of each secondary battery for evaluation was calculated. It can be said that as the output resistance value decreases, the output characteristics increase. The results are shown in Table 2.

TABLE 2

| | | | | | | Number of times of | Output |
|---|---|---|---|---|---|---|---|
| | Positive electrode | | | | | passing through | resistance |
| | active material | CNT | PVdF | Metal content | Catalytic metal | permanent magnet | value |
| | (% by mass) | (% by mass) | (% by mass) | (% by mass) | removal method | (number of times) | (mΩ) |
| Example 11 | 98.30 | 1.00 | 0.70 | 4.0 | None | 0 | 66.7 |
| Example 12 | 98.30 | 1.00 | 0.70 | 2.0 | Magnetic separation | 1 | 66.3 |
| | | | | | (paste) | | |
| Example 13 | 98.30 | 1.00 | 0.70 | 1.6 | Magnetic separation | 2 | 62.1 |
| | | | | | (paste) | | |
| Example 14 | 98.30 | 1.00 | 0.70 | 1.2 | Magnetic separation | 4 | 61.3 |
| | | | | | (paste) | | |
| Example 15 | 98.30 | 1.00 | 0.70 | 0.4 | Magnetic separation | 10 | 60.6 |
| | | | | | (paste) | | |
| Example 16 | 98.30 | 1.00 | 0.70 | 1.2 | Magnetic separation | 4 | 67.0 |
| | | | | | (powder) | | |
| Example 17 | 98.30 | 1.00 | 0.70 | 0.0 | Nitric acid cleaning | 0 | 66.2 |

As shown in Table 2, even when the composition ratio, basis weight, and porosity of the positive electrode active material layer are changed, by preparing a CNT paste, by performing magnetic separation on the CNT paste, and by separating CNT and metal, it was found that the output characteristics of the secondary battery are improved.

Specific examples of the technology disclosed herein have been described in detail above, but these are merely examples and do not limit the scope of the claims. The technology described in the claims includes various modifications and changes of the specific examples illustrated above.

What is claimed is:

1. A method for manufacturing a positive electrode of a secondary battery, the method comprising:
a carbon nanotube (CNT) paste preparing step of preparing a CNT paste including at least CNTs and a dispersing agent composed of a copolymer containing aromatic unit;
a magnetic separating step of exerting a magnetic force on the CNT paste to adsorb metal existing inside the CNTs and removing the metal from the CNTs;
a positive electrode active material layer forming paste preparing step of mixing the CNTs subjected to the magnetic separating step, a positive electrode active material, and a binder to prepare a positive electrode active material layer forming paste; and
a positive electrode active material layer forming step of applying the prepared positive electrode active material layer forming paste to a positive electrode current collector to form a positive electrode active material layer on the positive electrode current collector.

2. The method according to claim 1, wherein
the copolymer comprises pyrene or anthracene as the aromatic unit.

3. The method according to claim 1, wherein
the copolymer comprises a pyrene aromatic unit as the aromatic unit.

4. The method according to claim 1, wherein
a content of the dispersing agent composed of a copolymer containing aromatic unit is 1% by mass to 50% by mass when a mass of the CNTs is 100% by mass.

5. The method according to claim 1, wherein
the CNTs have a metal content of at least 4.0% by mass before the magnetic separating step when a total of the CNTs and the metal is 100% by mass, and
in the magnetic separation step, the metal is removed so that a metal content is 1.6 mass % by mass or less when a total of the CNTs and the metal is 100 mass %.

6. The method according to claim 1, wherein
the copolymer comprises a pyrene aromatic unit as the aromatic unit.
a content of the dispersing agent composed of a copolymer containing aromatic unit is 1% by mass to 50% by mass when a mass of the CNTs is 100% by mass.
the CNTs have a metal content of at least 4.0% by mass before the magnetic separating step when a total of the CNTs and the metal is 100% by mass, and
in the magnetic separation step, the metal is removed so that a metal content is 1.6 mass % by mass or less when the total of the CNTs and the metal is 100 mass %.

7. A method for manufacturing a secondary battery, comprising:
an electrode body fabrication process using the positive electrode manufactured by the method according to claim 1 and a negative electrode.
